(19) United States
(12) Patent Application Publication
(10) Pub. No.: US 2004/0173237 A1
(43) Pub. Date: Sep. 9, 2004

(54) System for cleaning substrates of flat panel display devices and method of cleaning using the same

(75) Inventor: Do-Hoon Park, Gyeongsangbuk-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 10/792,829

(22) Filed: Mar. 5, 2004

(30) Foreign Application Priority Data
Mar. 6, 2003 (KR) 2003-13988

(51) Int. Cl. B08B 1/02

(52) U.S. Cl. 134/1.3; 134/2; 134/15

(57) ABSTRACT

A system for cleaning a substrate of flat panel display devices includes an ultraviolet source providing ultraviolet light, a driver for moving the ultraviolet source along a first direction, and a track extended along a second direction perpendicular to the first direction, wherein the substrate is disposed upon the track to be provided to the ultraviolet source.

The present invention claims the benefit of Korean Patent Application No. P2003-013988 filed in Korea on Mar. 6, 2003, which is hereby incorporated by reference.

### BACKGROUND OF THE INVENTION

1. FIELD OF THE INVENTION

The present invention relates to a system for manufacturing a flat panel display device, and more particularly, to a system for cleaning a substrate for a flat panel display device and a method of cleaning using the same.

2. DISCUSSION OF THE RELATED ART

During manufacturing of flat panel display devices, which use glass as a substrate material, or manufacturing of semiconductor devices, which use silicon wafers as substrates, thin film patterning processes are repeatedly performed on a substrate. The thin film pattern processes include formation of conductor, dielectric, or semiconductor materials on the substrate, and may include single layers, such as electro-conductive lines of a circuit, or multi-layers, such as thin film transistor switching elements.

In general, photolithographic methods are commonly used to pattern thin films, thereby resulting in fine structures. The photolithographic methods include deposition of a thin film on a substrate, forming a photoresist on the thin film, selectively removing portions of the photoresist by exposing and developing the photoresist to selectively expose corresponding portions of the thin film, and selectively removing the exposed portions of the thin film.

Since flat panel display devices and their corresponding semiconductor devices are easily influenced by impurities, substrates should be highly cleaned during the manufacturing processes, wherein the cleaning processes are required before and after each individual process. For example, organic matter on a surface of the substrate must be removed before coating the photoresist, thereby cleaning the substrate and improving bonding of the photoresist to the substrate.

During the cleaning process of the substrate prior to coating the photoresist, the organic matter on the surface of the substrate may be ashed using O₂. Alternatively, the organic matter on the surface of the substrate may be oxidized and evaporated by ozone (O₃) or radicals that may have been formed from excitation of the O₂ atoms by ultraviolet (UV) light.

According to the related art, since the cleaning of the substrate occurs within a processing chamber, it is difficult to clean substrates of various sizes. Thus, as sizes of the substrates increase to produce large-sized flat panel display devices, the processing chamber must be designed and built, thereby increasing production costs and manufacturing time. In addition, since the cleaning process requires irradiation of UV light onto the surface of the substrates, any increase in the size of the substrates would require a corresponding increase in the time to irradiate the surface of the substrates.

### SUMMARY OF THE INVENTION

Accordingly, the present invention is directed to a system for cleaning substrates of flat panel display devices and a method of cleaning the substrates using the same that substantially obviate one or more of the problems due to limitations and disadvantages of the related art.

An object of the present invention is to provide a system for cleaning substrates of flat panel display devices having variably-sized substrates.

Another object of the present invention is to provide a method of cleaning substrates of flat panel display devices having variably-sized substrates.

Another object of the present invention is to provide a system for cleaning substrates of flat panel display devices having a reduced cleaning time.

Another object of the present invention is to provide a method of cleaning substrates of flat panel display devices having a reduced cleaning time.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system for cleaning a substrate of flat panel display devices includes an ultraviolet source providing ultraviolet light, a driver for moving the ultraviolet source along a first direction, and a track extended along a second direction perpendicular to the first direction, wherein the substrate is disposed upon the track to be provided to the ultraviolet source.

In another aspect, a method of cleaning a substrate of flat panel display devices using a cleaning system including an ultraviolet source providing ultraviolet light, a driver for moving the ultraviolet source along a first direction, and a track extended along a second direction perpendicular to the first direction, wherein the substrate is disposed on the track, the method includes fixing an illumination intensity of ultraviolet light from the ultraviolet source and a speed of the substrate on the track, controlling a distance between the substrate and the ultraviolet source depending upon the illumination intensity and the speed of the substrate, and moving the substrate on the track.

In another aspect, a method of cleaning a substrate of flat panel display devices using a cleaning system including an ultraviolet source providing ultraviolet light, a driver for moving the ultraviolet source along a first direction, and a track extended along a second direction perpendicular to the first direction, wherein the substrate is disposed on the track, the method includes determining an illumination intensity of ultraviolet light from the ultraviolet source, controlling a speed of the substrate on the track, controlling a distance between the substrate and the ultraviolet source depending upon the illumination intensity and the speed of the substrate, and moving the substrate on the track.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a schematic plan view of an exemplary system for cleaning substrates according to the present invention;

FIG. 2 is a cross sectional view of an exemplary system for cleaning substrates according to the present invention;

FIG. 3 is a graph showing changes of illumination intensity of UV light versus distances between a substrate and a light source; and

FIG. 4 is a schematic diagram of an exemplary method of cleaning substrates according to the present invention.

### DETAILED DESCRIPTION OF THE PREFERRED EMBODIMENTS

Reference will now be made in detail to an embodiment of the present invention, an example of which is illustrated in the accompanying drawings

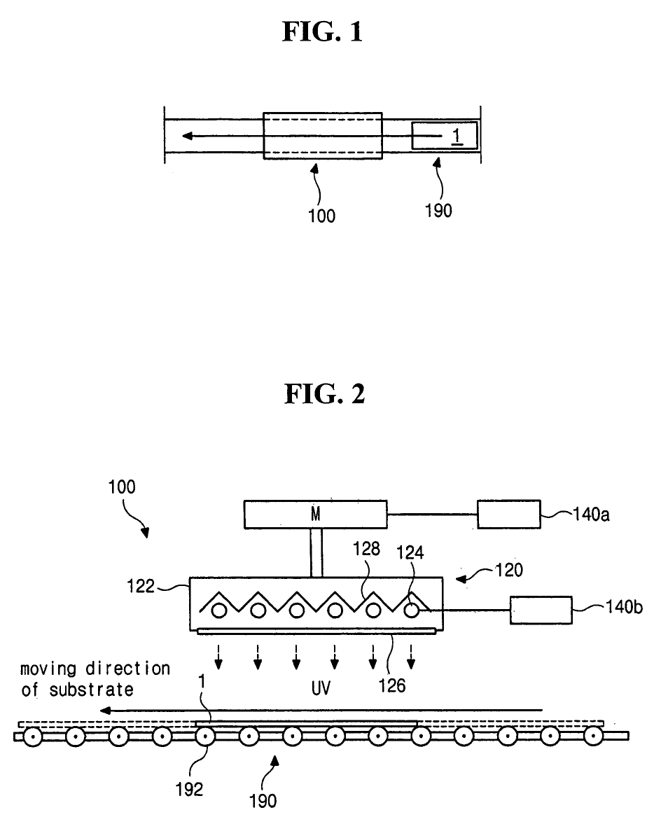

FIG. 1 is a schematic plan view of an exemplary system for cleaning substrates according to the present invention. In FIG. 1, a system may include a cleaning apparatus 100 and a track 190. The track 190 may supply a substrate 1 into the cleaning apparatus 100 to be cleaned, and may remove the cleaned substrate 1 from the cleaning apparatus 100. The track 190 may function as a transfer module, and may be a part of the cleaning apparatus 100. In addition, the substrate 1 may be cleaned using an in-line method process, wherein the substrate 1 may be cleaned while passing through the cleaning apparatus 100 along the track 190.

FIG. 2 is a cross sectional view of an exemplary system for cleaning substrates according to the present invention. In FIG. 2, the cleaning apparatus 100 may include a UV source 120, the track 190, and a driving system M. The UV source 120 may provide UV light along a first direction, and the track 190 may supply the substrate 1 to the cleaning apparatus 100 to expose a surface of the substrate 1 to the UV source 120. The driving system M may move the UV source 120 along a second direction (i.e., irradiating direction) perpendicular to the first direction. For example, the UV source 120 may irradiate the UV light directly downward along the second direction, wherein the track 190 may provide the substrate 1 beneath the UV source 120.

The UV source 120 may include a housing 122, a light source 124, a transparent insulating plate 126, and a reflecting plate 128. The housing 122 may have an opened lower portion, wherein the transparent insulating plate 126 may close the lower portion of the housing 122. The light source 124 may be disposed within the housing 122, and may emit the UV light. The reflecting plate 128 may be disposed within the housing 122 to face the transparent insulating plate 126, and may condense the UV light emitted by the light source 124 toward the transparent insulating plate 126. The light source 124 may include at least one low-pressure mercury lamp to emit UV light having a wavelength within a range of about 185 nm to about 254 nm, or at least one dielectric barrier discharge lamp to emit UV light having a wavelength of about 172 nm.

In FIG. 2, the track 190 may have a plurality of driving rollers 192 to be arranged in a line that may each rotate along the first direction. Accordingly, the substrate 1 may move along uppermost portions of the plurality of driving rollers 192.

According to the present invention, the UV source 120 of the cleaning apparatus 100 may move along the second direction in upward and downward directions by the driving system M. The driving system M may include various structures. Although not shown, the driving system M may have a power generating part for generating rotary motion, such as electric and hydraulic motors, a power conversion part to convert the rotary motion into axial motion along the second direction, such as a power screw and a cylinder, and at least a driving shaft connecting the power conversion part to the UV source 120 to move the UV source 120 along the second direction in the upward and downward directions.

The cleaning apparatus 100 may include first and second power suppliers 140a and 140b, each of the first and second power suppliers 140a and 140b may jointly share a power supply. Alternatively, each of the first and second power suppliers 140a and 140b may use individual power supplies.

During an exemplary method of cleaning the substrate 1 using the cleaning apparatus of FIG. 2, a cleaning rate of the substrate 1 may be dependent upon an irradiating amount of UV light from the UV source 120, irradiating time of the UV light, and a distance between the substrate 1 and the UV source 120. Optimum cleaning effects for the substrate 1 may be attained by controlling at least these three conditions. For example, the irradiating amount of the UV light may be adjusted by controlling power provided to the light sources 124 while measuring an intensity of illumination of the light source 124. In addition, the irradiating time of the UV light may be controlled by a rotating speed of the driving rollers 192. If the driving rollers 192 rotate too fast, an exposure time of the substrate 1 to the UV light may be too short. Conversely, if the driving rollers 192 rotate too slowly, an exposure time of the substrate 1 to the UV light may be too long.

According to the present invention, a distance between the UV source 120 and the substrate 1 may be controlled to obtain improved cleaning effects, as shown in Table 1.

TABLE 1

| Irradiating | Distance between | Irradiating |
|---|---|---|
| amount | substrate and light source | time |
| controllable | controllable | controllable |

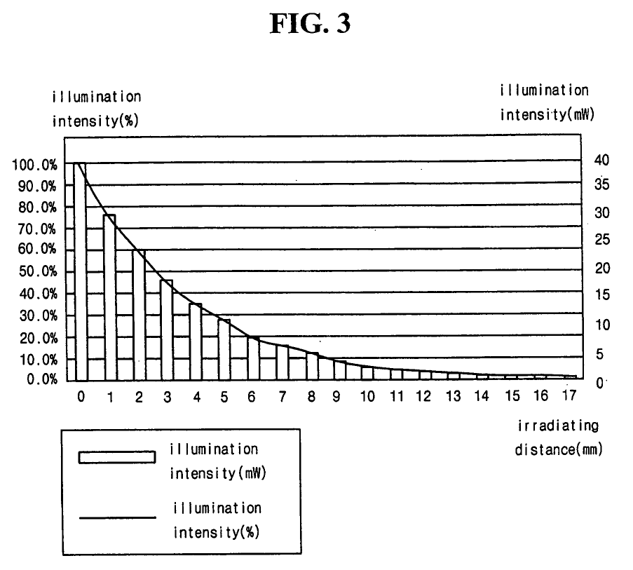

FIG. 3 is a graph showing changes of illumination intensity of UV light versus distances between a substrate and a light source. In FIG. 3, illumination intensity of the UV light exponentially decreases according to an increase in distance between the substrate 1 and the light source 124 since the UV light is easily absorbed into oxygen. Accordingly, the total energy of the irradiated UV light may be calculated as follows:

E_{T}=I_{LS} ×T₁×D (1)

wherein _{ET} is the total energy of the UV light in mJ, I_{LS} is the illumination intensity of the light source in mW, T₁ is the irradiating time in seconds, and D is the decreasing coefficient according to a distance between the substrate and the light source.

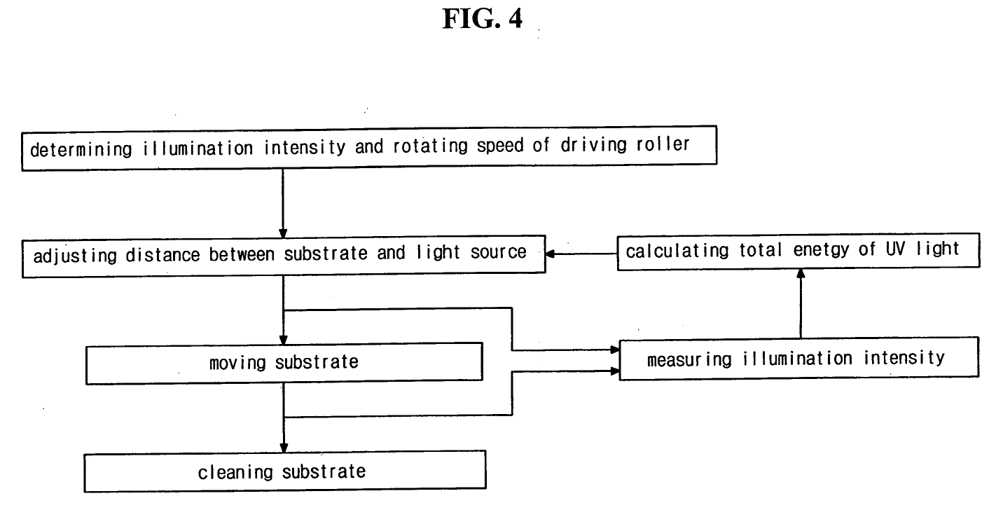

FIG. 4 is a schematic diagram of an exemplary method of cleaning substrates according to the present invention. In FIG. 4, an illumination intensity of the light source 124 and rotating speed of the driving rollers 192 may be determined and fixed before being a cleaning process. For example, the distance between the light-source 124 and the substrate 1 may be calculated from Equation 1.

While the illumination intensity of the light source 124 may be measured at regular time intervals, the distance between the light source 124 and the substrate 1 may be adjusted. Simultaneously, the substrate 1 located on the plurality of driving rollers 192 may pass beneath the UV source 120 by sliding along the uppermost portions of the driving rollers 192 along the first direction. In addition, the UV source 120 may be moved along the second direction by about 0.1 mm increments in the upward and downward directions. Thus, the substrate 1 may be cleaned using the cleaning system according to the present invention.

Alternatively, although not shown, the UV source 120 may be moved along the first direction while the substrate 1 remains stationary. Furthermore, the UV source 120 may move along the first direction and the substrate 1 may move along another direction opposite to the first direction. Even further, the UV source 120 and the substrate 1 may move in relative different directions to reduce total cleaning time.

According to the present invention, the exemplary cleaning system may have an in-line configuration, wherein the substrate 1 is moved and simultaneously cleaned. Thus, loading/unloading robots for loading and unloading the substrate 1 may not be necessary, thereby reducing cleaning processing time. In addition, since the distance between the substrate 1 and the light source 124 may be easily adjusted, effective cleaning may be achieved for a short time as compared with exponentially changing an illumination intensity of the UV-light, as shown in FIG. 3.

According to the present invention, illumination intensity of a UV light source may not have to be unnecessarily changed since irradiating amounts of the UV light may be controlled depending on the distance between the substrate and the light source. Moreover, since the UV light source may remain ON during repeated cleaning cycles, the illumination intensity of the UV light may remain constant. This will decrease any error between a desired total energy of the UV light and real total energy of the UV light.

It will be apparent to those skilled in the art that various modifications and variations can be made in the system for cleaning substrates of flat panel display devices and method of cleaning using the same of the present invention without departing from the spirit or scope of the invention. Thus, it is intended that the present invention covers the modifications and variations of this invention provided they come within the scope of the appended claims and their equivalents.

What is claimed is:

1. A system for cleaning a substrate of flat panel display devices, comprising:
an ultraviolet source providing ultraviolet light;
a driver for moving the ultraviolet source along a first direction; and
a track extended along a second direction perpendicular to the first direction,
wherein the substrate is disposed upon the track to be provided to the ultraviolet source.

2. The system according to claim 1, wherein the ultraviolet source irradiates the ultraviolet light along the first direction and the track is disposed beneath the ultraviolet source.

3. The system according to claim 2, wherein the ultraviolet source includes:
a light source irradiating the ultraviolet light;
a reflecting plate disposed beneath the light source for condensing the irradiated ultraviolet light;
a housing enclosing the light source and having an opened lower portion; and
a transparent insulating plate enclosing the opened lower portion of the housing.

4. The system according to claim 3, wherein the light source includes at least one lamp.

5. The system according to claim 4, wherein the lamp is one of a low-pressure mercury lamp and a dielectric barrier discharge lamp.

6. The system according to claim 2, wherein the track includes a plurality of rollers arranged along the second direction such that a length of each roller extends along a third direction perpendicular to the first and second directions, and each roller rotates about an axis extending along the third direction.

7. The system according to claim 1, wherein the driver includes:
a power generating part for generating rotary motion along the second and third directions;
a power conversion part for changing the rotary motion into an axial motion along the first direction; and
a connecting part for connecting the power conversion part to the ultraviolet source and moving the ultraviolet source along the first direction in upward and downward directions.

8. The system according to claim 7, wherein the power generating part includes one of electric motors and hydraulic motors.

9. The system according to claim 7, wherein the power conversion part includes a power screw and a cylinder.

10. The system according to claim 7, wherein the connecting part includes at least one drive shaft.

11. The system according to claim 1, wherein a rotating speed of each roller, illumination intensity of the ultraviolet light, and a distance between the substrate and the ultraviolet source is controlled while the substrate is cleaned.

12. The system according to claim 11, wherein the distance between the substrate and the ultraviolet source is adjusted by about 0.1 mm increments.

13. A method of cleaning a substrate of flat panel display devices using a cleaning system including an ultraviolet source providing ultraviolet light, a driver for moving the ultraviolet source along a first direction, and a track extended along a second direction perpendicular to the first direction, wherein the substrate is disposed on the track, the method comprising:
fixing an illumination intensity of ultraviolet light from the ultraviolet source and a speed of the substrate on the track;
controlling a distance between the substrate and the ultraviolet source depending upon the illumination intensity and the speed of the substrate; and
moving the substrate on the track.

14. The method according to claim 13, wherein total energy of the ultraviolet light irradiated on the substrate is determined as a product of illumination intensity, exposing time of the substrate to the ultraviolet light, and a decreasing coefficient according to the distance between the substrate and the ultraviolet source.

15. The method according to claim 13, wherein the controlling a distance between the substrate and the ultraviolet source includes changing the distance by about 0.1 mm increments.

16. The method according to claim 13, wherein the controlling a distance between the substrate and the ultraviolet source includes:
generating rotary motion along the second and third directions using a power generating part;
converting the rotary motion into an axial motion along the first direction using a power conversion part; and
connecting the power conversion part to the ultraviolet source and moving the ultraviolet source along the first direction in upward and downward directions using a connecting part.

17. A method of cleaning a substrate of flat panel display devices using a cleaning system including an ultraviolet source providing ultraviolet light, a driver for moving the ultraviolet source along a first direction, and a track extended along a second direction perpendicular to the first direction, wherein the substrate is disposed on the track, the method comprising:
determining an illumination intensity of ultraviolet light from the ultraviolet source;
controlling a speed of the substrate on the track;
controlling a distance between the substrate and the ultraviolet source depending upon the illumination intensity and the speed of the substrate; and
moving the substrate on the track.

18. The method according to claim 17, wherein total energy of the ultraviolet light irradiated on the substrate is determined as a product of illumination intensity, exposing time of the substrate to the ultraviolet light, and a decreasing coefficient according to the distance between the substrate and the ultraviolet source.

19. The method according to claim 17, wherein the controlling a distance between the substrate and the ultraviolet source includes changing the distance by about 0.1 mm increments.

20. The method according to claim 17, wherein a speed of the substrate, illumination intensity of the ultraviolet light, and the distance between the substrate and the ultraviolet source are controlled while the substrate is cleaned.

21. The method according to claim 17, wherein the controlling a distance between the substrate and the ultraviolet source includes:
generating rotary motion along the second and third directions using a power generating part;
converting the rotary motion into an axial motion along the first direction using a power conversion part; and
connecting the power conversion part to the ultraviolet source and moving the ultraviolet source along the first direction in upward and downward directions using a connecting part.
